(19) United States
(12) Patent Application Publication
(10) Pub. No.: US 2024/0362062 A1
(43) Pub. Date: Oct. 31, 2024

(54) TASK CLUSTERING MODEL

(71) Applicant: International Business Machines Corporation, Armonk, NY (US)

(72) Inventors: Diane Chalmers, Rochester, MN (US); Kelley Anders, East New Market, MD (US)

(21) Appl. No.: 18/308,896

(22) Filed: Apr. 28, 2023

(51) Int. Cl. G06F 9/48

(52) U.S. Cl. CPC G06F 9/4881

(57) ABSTRACT

A system may include a memory and a processor in communication with the memory. The processor may be configured to perform operations. The operations may include obtaining social interaction data for a user and monitoring a system for activity of the user. The operations may include analyzing the activity and the social interaction data to obtain an analysis. The operations may include performing statistical linear regression on the activity and the social interaction data to obtain statistical linear regression data. The operations may include deriving a task clustering model based on the analysis and the statistical linear regression data.

### BACKGROUND

The present disclosure relates to automation and more specifically to automation of related tasks via task clustering.

People may engage in tasks throughout a day. Tasks may be important or unimportant, necessary or unnecessary, urgent or not urgent, similar to or dissimilar from historical tasks and/or actions necessary to complete the tasks, related or unrelated to other tasks, correlate with other tasks, and the like. Tasks may individually have one of these characteristics or some combination of these characteristics. For example, some tasks may be simultaneously necessary and repetitive, and some tasks may be repetitive and have a high correlation with other tasks.

### SUMMARY

Embodiments of the present disclosure include a system, method, and computer program product for task clustering and automation.

A system in accordance with the present disclosure may include a memory and a processor in communication with the memory. The processor may be configured to perform operations. The operations may include obtaining social interaction data for a user and monitoring a system for activity of the user. The operations may include analyzing the activity and the social interaction data to obtain an analysis. The operations may include performing statistical linear regression on the activity and the social interaction data to obtain statistical linear regression data. The operations may include deriving a task clustering model based on the analysis and the statistical linear regression data.

The above summary is not intended to describe each illustrated embodiment or every implementation of the disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1A illustrates a graphic of data analysis and identification of related tasks in accordance with some embodiments of the present disclosure.

FIG. 1B depicts a visual representation of an analysis showing task relationships in accordance with some embodiments of the present disclosure.

FIG. 2 illustrates a diagram of action analysis in accordance with some embodiments of the present disclosure.

FIG. 3 depicts a task relationship database table in accordance with some embodiments of the present disclosure.

FIG. 4 illustrates an interactive visual in accordance with some embodiments of the present disclosure.

FIG. 5 depicts a computer-implemented method in accordance with some embodiments of the present disclosure.

FIG. 6 illustrates a computer-implemented method in accordance with some embodiments of the present disclosure.

FIG. 7 depicts a block diagram of an example computing environment in which illustrative embodiments of the present disclosure may be implemented.

FIG. 8 illustrates a block diagram of an example natural language processing system configured to analyze a recording to identify a particular subject of a query, in accordance with embodiments of the present disclosure.

FIG. 9 depicts a block diagram illustrating an embodiment of a computer system, and the components thereof, upon which embodiments described herein may be implemented in accordance with the present disclosure.

FIG. 10 illustrates a block diagram illustrating an extension of the computing system environment of FIG. 9 wherein the computer systems are configured to operate in a network environment (including a cloud environment) and perform methods described herein in accordance with the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to automation and more specifically to automation of related tasks via task clustering.

Some tasks, such as manual tasks, may become repetitive and tedious. Manual tasks that may become monotonous may include, for example, gathering weekly agenda topics and/or copying items from a shared folder into a presentation or an instant messaging channel. Although the text may differ each time, the tasks themselves may be repetitive.

Certain indicators may connote a repetitive task, and such indicators may be used to cluster similar items to identify potential combinations for automation. The present disclosure may, in some embodiments, enable the identification of such indicators and/or be used to identify and/or cluster tasks as candidates for automation. In some embodiments, the present disclosure may enable such automation by, for example, generating a task clustering model (TCM) to identify such tasks. For example, a TCM may be used to identify and highlight the strength of correlated tasks (e.g., similar tasks or sequential tasks). In some embodiments, a TCM may provide a visual of weighted relationships of clustered tasks.

A TCM may be deployed in a constrained environment (e.g., an environment with a given set of constraints); examples of constrained environments may include alternative reality, augmented reality, and/or virtual reality (collectively, AR/VR). For example, a TCM implemented in an AR/VR environment may be used to determine how an avatar should operate within a given set of constraints (e.g., the constraints of the particular AR/VR).

In some embodiments of the present disclosure, data may be obtained, analyzed, and assessed to achieve a model (e.g., a TCM) which may be used to cluster and/or automate related tasks. For example, the activity of a user may be monitored to obtain user activity data; the activity of the user may include one or more actions of the user and one or more social interactions of the user. In some embodiments, actions of the user may include social interactions of the user; in some embodiments, social interactions of the user may be obtained separately from that of the actions (e.g., the social interactions may be input from an external database and the actions may be tracked via keystrokes). The activity data may be analyzed to obtain an activity analysis and statistical linear regression may be performed on the activity data to obtain statistical linear regression analysis. The activity analysis and the statistical linear regression analysis may be used to generate a model (e.g., a TCM). The model may be used to identify relationships between tasks and thus identify opportunities for automation.

In some embodiments, a task clustering model may identify a strong relationship between task A and task B. The task clustering model may determine that a user performed task A and is thus likely to perform task B; thus, the task clustering model may offer to perform task B for the user. For example, the task clustering model may conclude with a 90% confidence score that when a user is added as a collaborator in a shared folder that the same collaborator is added to an internal messaging chat room; the task clustering model may detect that a collaborator was added to the shared folder and prompt the user with an offer to add the same collaborator to the internal messaging chat room.

In some embodiments of the present disclosure, a task clustering model (TCM) may identify mutual relationships as well as non-mutual relationships. For example, the TCM may determine with 95% confidence that a collaborator added to a certain shared folder will also be added to a certain discussion channel and that the reverse also applies, specifically, that if the collaborator is added to the certain discussion channel that the model will determine with 95% confidence that the collaborator will also be added to the certain shared folder. Such a relationship could be considered a mutual relationship as one indicates the other and vice versa.

In some embodiments, a non-mutual relationship may be identified. For example, a TCM may conclude with 95% confidence that a collaborator added to a certain shared folder will be added to an instant messaging group; the model may determine that a collaborator added to the same instant messaging group will not necessarily be added to that shared folder. As an example, the TCM may determine that there is a 95% confidence that a collaborator added to a certain shared folder will be added to a large group chat (e.g., a company-wide instant messaging channel) and a 95% chance that the collaborator will also be added to a small group chat (e.g., an instant messaging channel sharing the topic name with the folder). In the same example, the TCM may determine that a collaborator added to the large group chat (e.g., the company-wide group chat) has a 7% likelihood of being added to the shared folder; the TCM may determine with 95% confidence that a collaborator added to the small group chat (e.g., the topic-specific instant messaging channel) will be added to the large group chat (e.g., the company-wide group chat) and determine with a 57% confidence that the collaborator will be added to the shared folder. In such an example, the relationship may not be considered mutual because the first action may strongly indicate the second action but the second action may not similarly indicate the first action.

A system may be monitored to capture actions and/or inactions. Actions may include, but are not limited to, keystrokes, mouse clicks, and similar activity. Activity may include, for example, visiting a website, opening a bookmark whether internal (e.g., within a local system) or external (e.g., accessible via a networked system and/or the internet), and/or achieving an outcome (e.g., saving a file, moving a file to a different location such as to a different folder or to the trash, closing a tab, and/or copying text).

In the present disclosure, the terms action and activity may be used interchangeably. Actions may be any sort of activity or inactivity conducted by a user. For example, an action may be selecting a file, opening a program, viewing a file, copying text (e.g., by selecting the text and manually directing a computer to copy the text or by using hotkeys), pasting text (e.g., either manually or by using hotkeys), uploading a file, adding a collaborator, removing a collaborator, launching a presentation, starting a web conference, writing a certain line of code, a prompt that lacks response from a user (e.g., times out after five minutes), and the like.

In some circumstances, inaction may be an action. For example, a system may track the actions of a user, the system may provide the user with a prompt, and the user may ignore the prompt; the system may track the refusal to interact with the prompt as an action indicating that the user is not interested in pursuing the action offered by the prompt. In some embodiments, the prompt may have a predetermined time-out period (e.g., five minutes or an hour) such that inaction will be tracked after the predetermined time-out period. For example, a prompt may notify a user of a virtual meeting in five minutes and recommend launching the virtual meeting room; the predetermined time-out period may be set for fifteen minutes such that the inaction is tracked after fifteen minutes of non-interaction with the prompt. In another example, a prompt may notify a user that a collaborator was added to a shared folder and recommend adding that collaborator to a related instant messaging channel; the prompt may have a predetermined time-out period of two hours such that a lack of interaction with the prompt is tracked two hours after the prompt notifies the user of the recommendation.

Actions may be performed by a user in a variety of contexts and the related data may be tracked specific to the context. Contexts may include, for example, working on a meeting agenda, drafting a meeting presentation, writing emails, working on building an application, participating in a department-wide instant messaging channel, discussing a certain topic in a project-specific instant messaging channel, participating in a department virtual group call, engaging in a small group virtual discussion call, and the like.

Actions may be tracked within contexts. For example, a user may be writing a new meeting agenda; the user may copy a certain segment of text from a previous meeting agenda and paste the segment into the new meeting agenda. The system may identify with 95% confidence that the user will copy the same segment of text and paste it into a new meeting agenda each time the user starts a new meeting agenda; the system may offer to copy and paste the text when the user starts drafting a new meeting agenda. In some embodiments, the system may track that multiple segments are copied and pasted from previous meeting agendas; in some embodiments, the system may offer to copy and paste each of the segments when the user starts writing a new meeting agenda, and in some embodiments, the system may offer a template with the identified text to be copied and pasted already present on the template agenda.

A variety of contexts may be identified within particular programs, applications, and/or other tools. Programs, applications, and/or other tools may include, for example, file sharing programs, word processing applications, presentation programs, instant messaging tools, email communication clients, webinar applications, telecommunications software (e.g., voice-over-internet protocol tools), web conferencing programs (e.g., videoconferencing platforms), illustration software, publishing programs, and the like. The system may track actions within a tool with an identified context.

The system may track actions of a user using a particular tool for a certain context and analyze the actions tracked to identify concepts, entities, common keywords, and the like. The actions may be analyzed using one or more techniques known in the art or hereinafter developed such as, for example, corpus linguistics, Latent Dirichlet Analysis, BiTerm Analysis, and natural language processing (NLP). Analyzing the actions may result in an output of an analysis that may include, for example, concepts, entities, common keywords, other similarities, differences, identified sequences, correlated trends, causation and/or correlation confidence scores, quantified relatedness scores, action location correlations, and the like.

In some embodiments, the analysis resulting from analyzing the actions may be used to derive a TCM. The TCM may cluster similar tasks and/or tasks in a repeated sequence. The TCM may incorporate various types of data such as data about one or more actions, action locations, similarities of content within artifacts (e.g., whether the same agenda item is consistently copied or if sometimes a uniform resource locator (URL) is copied instead), action sequences (e.g., the same keyboard shortcuts used in the same combined sequence and whether the sequence happens across multiple applications), correlation confidence scores, causation confidence scores, social interactions, and the like.

In some embodiments of the present disclosure, statistical linear regression may be used. For example, statistical linear regression may be used to determine one or more confidence scores such as confidence scores related to correlation, causation, relatedness, and the like.

In some embodiments, social interaction data may be used. Social interaction data may be obtained directly (e.g., obtaining user permission and tracking user social media interactions) or via other mechanisms which may be known in the art. Social interaction data may include, for example, crowd sourcing proclivities, social media posting history, social media engagement, and the like. Social interaction data may be used based on degree of separation to determine which tasks may be candidates for clustering and/or potential automation according to user preference.

In some embodiments of the present disclosure, social interaction data may be used to weight and/or visualize one or more related relationships between clustered tasks. In some embodiments, visual weighted relationships using social interaction data may be achieved by, for example, displaying representation in a database table with scored and/or clustered indices representing task relationships. In some embodiments, visual weighted relationships using social interaction data may be achieved by, for example, k-nearest neighbor (k-NN) mapping.

Weighted relationships (e.g., visual weighted relationships) may be stored within a system for future learning. The system may, for example, identify that users added to a specific project are then added to a related instant messaging channel and a related shared folder; as a result, the system may track that correlation, identify a similar circumstance such that a user added a collaborator to an instant messaging channel, and prompt the user with an option to add the collaborator to the related shared folder. The system may employ a model to assess task relatedness, identify a task within a cluster of related tasks has been completed, and/or prompt the user with an option to perform a related task within the cluster of related tasks.

In some embodiments of the present disclosure, a task clustering model (TCM) may be generated. The TCM may be used to identify and highlight the strength of correlated similar or sequential tasks. The TCM may also be used to provide a visual of the weighted relationships of the clustered tasks. A method in accordance with the present disclosure may include monitoring actions while a user interacts with a graphical user interface. The method may further include identifying concepts, entities, and common keywords within the monitored actions using one or more analytics techniques. The method may further include deriving a task clustering model (TCM) from the identified concepts, entities, and common keywords. In some embodiments, the method may further include identifying clustered tasks and providing the user with a visual of the weighted relationships of the clustered tasks.

Weighting may be shown visually. For example, weighting may be shown with a map, colors, coloration scales, and/or a dialog box. Weighting may be shown with a map (e.g., a network map) such that the nearness of nodes may be scaled to the closeness of the relationships and/or that the differing sizes and/or thicknesses (e.g., the size of the nodes and/or the connections between nodes) may be scaled to the strength of the relationships.

Weighting may be shown with colors; for example, green may indicate a close relationship, yellow may indicate a moderate relationship, and red may indicate little to no relationship. Weighting may be shown with coloration scales. A coloration scale may employ the darkest color in the selected spectrum to indicate the closest relationship; for example, a navy blue may indicate a stronger relationship than a pastel blue. Some coloration scales may be used in the inverse such that the lightest color in the color spectrum may indicate the closeness of the relationship; for example, on such a scale, a pastel blue may indicate a stronger relationship than a navy blue.

Weighting may be shown with a dialog box. For example, the weighting may be represented via a notification of a related task with an indication of the relationship strength (e.g., with a phrase, numerical confidence score, and/or graphic such as a network map). The weighting notification dialog box may be or include a prompt that offers completing a related task.

In some embodiments of the present disclosure, the TCM may provide a visual of the weighted relationships of the clustered tasks. In some embodiments, the TCM may consider correlated similar tasks which may or may not be sequential. In some embodiments, the TCM may identify and/or highlight the correlation strengths of similar, related, and/or sequential tasks. The strength of correlations may be specific to an action, tool, and/or context. In some embodiments, the TCM may provide a visual of the weighted relationships of the clustered tasks.

In some embodiments, the TCM may make recommendations of next actions based on the correlations of similar tasks across multiple applications. In some embodiments, the present disclosure may identify and highlight the strength of correlations of similar, related, and/or sequential tasks and thereby provide a visual of the weighted relationships of the clustered tasks.

In some embodiments, the present disclosure may enable the association of correlated similar, related, or sequential tasks and/or the weighted relationships of those tasks. For example, a TCM may be used to identify and highlight the strength of correlated similar, related, or sequential tasks as well as to provide a visual of the weighted relationships of clustered tasks. In some embodiments, the TCM may be used by either the sender or the receiver of messages or the intersection thereof.

In some embodiments of the present disclosure, a TCM may identify one or more correlations of tasks that an individual user may perform across multiple applications (e.g., a combination of web-based applications and non-web-based applications). The TCM may identify and highlight the strength of correlated similar, related, and/or sequential tasks and provide a visual of the weighted relationships of clustered tasks.

In some embodiments of the present disclosure, a model may be used for correlating similar, related, and/or sequential tasks and providing a visual of weighted relationships to predict and/or suggest a next action a user might want to take. The model may be used to identify and/or highlight the strength(s) of correlated similar, related, and/or sequential tasks and provide a visual of the weighted relationships of the clustered tasks.

In some embodiments of the present disclosure, a model may be used to provide a visual of weighted relationships of clustered tasks. In some embodiments, the visual of the weighted relationships of the clustered tasks may be used to provide a suggested next action. In some embodiments, the present disclosure considers and/or uses the correlations of tasks that an individual user may perform across multiple applications.

A system in accordance with the present disclosure may include a memory and a processor in communication with the memory. The processor may be configured to perform operations. The operations may include obtaining social interaction data for a user and monitoring a system for activity of the user. The operations may include analyzing the activity and the social interaction data to obtain an analysis. The operations may include performing statistical linear regression on the activity and the social interaction data to obtain statistical linear regression data. The operations may include deriving a task clustering model based on the analysis and the statistical linear regression data.

In some embodiments of the present disclosure, the operations may include generating a visual with the task clustering model. In some embodiments, the operations may include providing a visual of a weighted relationship. In some embodiments, the operations may include providing the visual to the user, observing a user interaction between the user and the visual, and incorporating the user interaction into a learning database.

In some embodiments of the present disclosure, the operations may include identifying related tasks within the activity with the task clustering model. In some embodiments, the operations may include providing a visual of a weighted relationship of the related tasks.

In some embodiments of the present disclosure, the operations may include weighting relationships of the related tasks based on the social interaction.

In some embodiments of the present disclosure, the operations may include implementing the task clustering model in an environment with a given set of constraints. In some embodiments, the environment with given constraints may be an AR/VR environment.

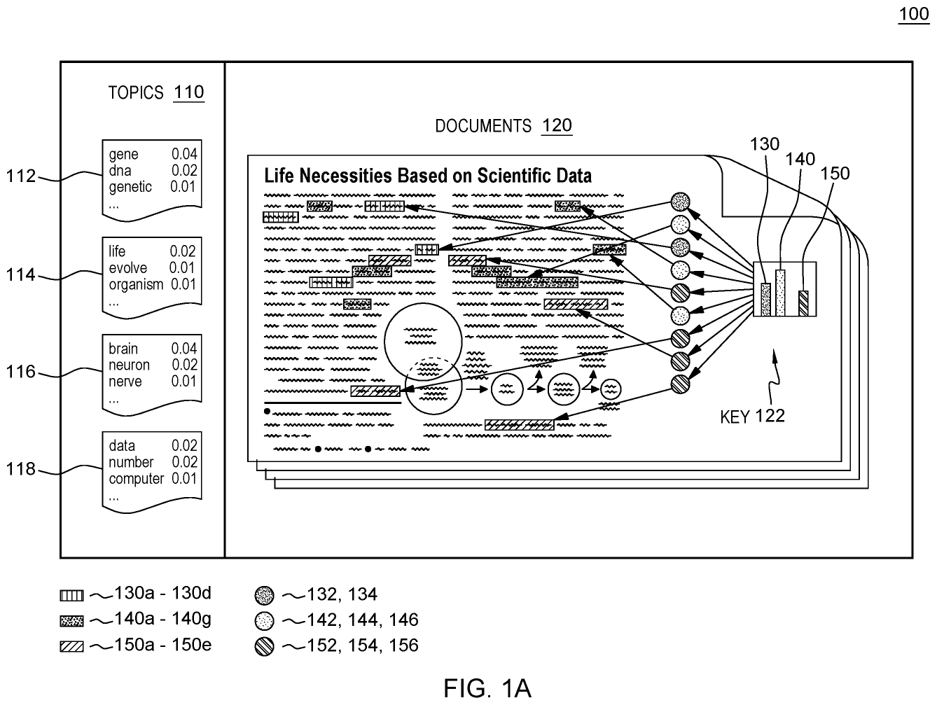

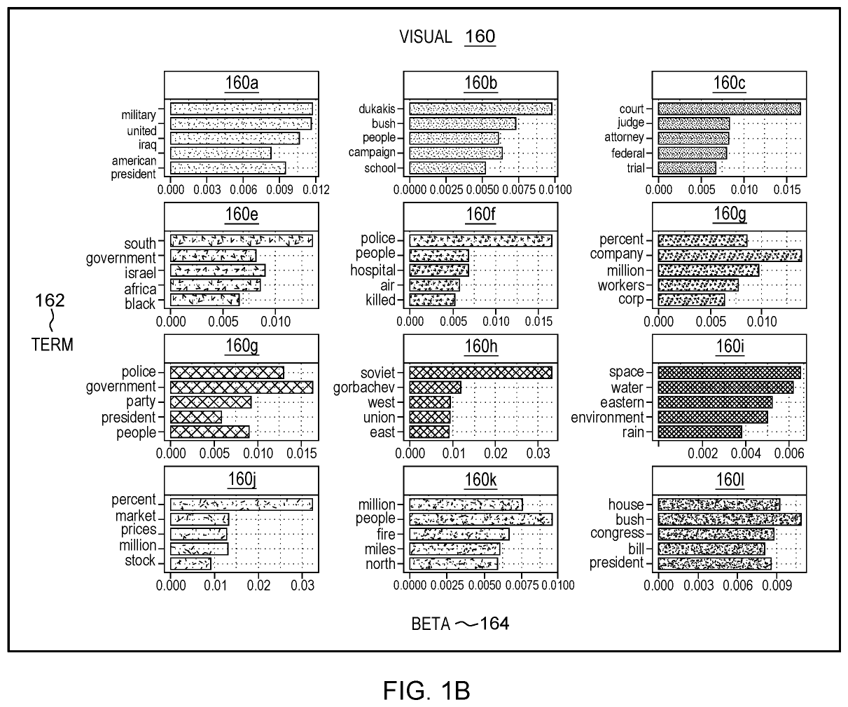

FIG. 1A illustrates a graphic 100 of data analysis and identification of related tasks in accordance with some embodiments of the present disclosure. The graphic 100 includes topics 110 and documents 120.

The topics 110 include keyword groupings 112-118. Each of the keyword groupings 112-118 include keywords for a particular topic. For example, the first keyword grouping 112 includes words that indicate reference to a genetic component such as a discussion about variation of life forms based on identified alleles. For example, the second keyword grouping 114 includes words that indicate reference to a living creature such as a discussion about what changes occurred to give us an organism currently studied and the evolution that likely took place from the existence of an ancestral life form. For example, the third keyword grouping 116 includes words that indicate reference to neural functions such as a discussion about scans taken of the brain and neural patterns identified thereby. For example, the fourth keyword grouping 118 includes words that indicate reference to technology such as a discussion about the information used to build a model to thereby identify trends in a dataset.

The documents 120 showcases an annotated article with various keywords highlighted therein. The article includes a key graph 122 that provides a visual of the occurrence rate of a first topic 130, a second topic 140, and a third topic 150. Various keyword groups 132, 134, 142, 144, 146, 152, 154, and 156 were used to identify data for the key graph 122. Each of the keyword groups 132, 134, 142, 144, 146, 152, 154, and 156 include keywords 130a-130d, 140a-140d, and 150a-150e that are tracked in the article. A keyword may be a word or a phrase.

In an article, various keywords 130a-130d, 140a-140d, and 150a-150e may be tracked, compiled into keyword groups 132, 134, 142, 144, 146, 152, 154, and 156, and used as data such as, for example, to identify trends and/or article relevance to certain topics (e.g., topics 110) which may be displayed in a visual (e.g., a key graph 122). This data may be analyzed to render an analysis (e.g., identify trends) of one or more available resources.

Similarly, in accordance with the present disclosure, data may be obtained about a user, which may include user social interaction data and user activity data, and the data may be analyzed to identify trends (e.g., correlations and causations).

FIG. 1B depicts a visual representation 160 of an analysis showing task relationships in accordance with some embodiments of the present disclosure. The visual representation 160 includes a first axis of terms 162 and a second axis of beta 164, that is, model instance.

The terms 162 may be keywords used to identify the frequency of reference to a certain topic (e.g., topics 110 of FIG. 1A). Each topic has a topic graph 160a-1601 which may show a confidence score that the keyword indicates the discussion of that particular topic and/or the frequency of a keyword within the topic. In some embodiments, the shading (e.g., highlight color or pattern) within a topic may match to enable a user to track back to instances within articles.

Some keywords may be used for multiple topics. For example, the keyword “government” may refer to international relations as shown in the fourth topic graph 160e and/or it may refer to domestic relations as shown in the seventh topic graph 160g. In some embodiments of the present disclosure, context may be used to determine which topic is the better fit for a keyword instance. In some embodiments, the same instance of a keyword may be tracked for both topics which may track the likelihood of reference to the specific topic. In some instances, similar or different mechanisms may be used, such as requiring distinct keywords for all topics.

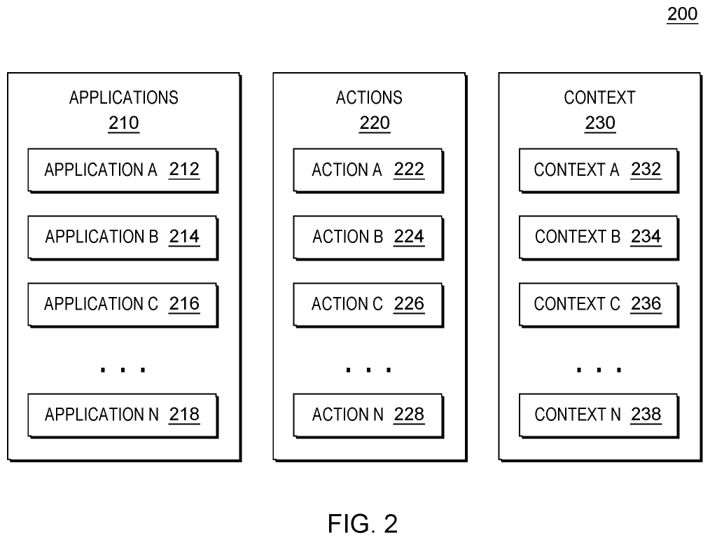

FIG. 2 illustrates a diagram 200 of action analysis in accordance with some embodiments of the present disclosure. The diagram 200 includes multiple data categories including data about applications 210, actions 220, and contexts 230.

Multiple applications 210 may be tracked as well as the actions 220 and the contexts 230 involved. For example, a user may use application A 212, application B 214, application C 216, and application N 218 simultaneously for performing action B 224 and action N 228 in context C 236. Similarly, a user may use application C 216 to perform action A 222, action B 224, action C 226, and action D 228 in context N 238. Likewise, a user may use application N 218 to perform action A 222 in context A 232, context B 234, context C 236, and context N 238.

In some embodiments of the present disclosure, a system may track the actions 220 used in all of the open applications 210 of the system as well as track the one or more contexts 230 and/or situational data surrounding the actions 220. In some embodiments, the tracked data may retain referential integrity across the different categories (e.g., in one-to-many relationships such that action A 222 may be used in application A 212 or in application C 216 and in context B 234).

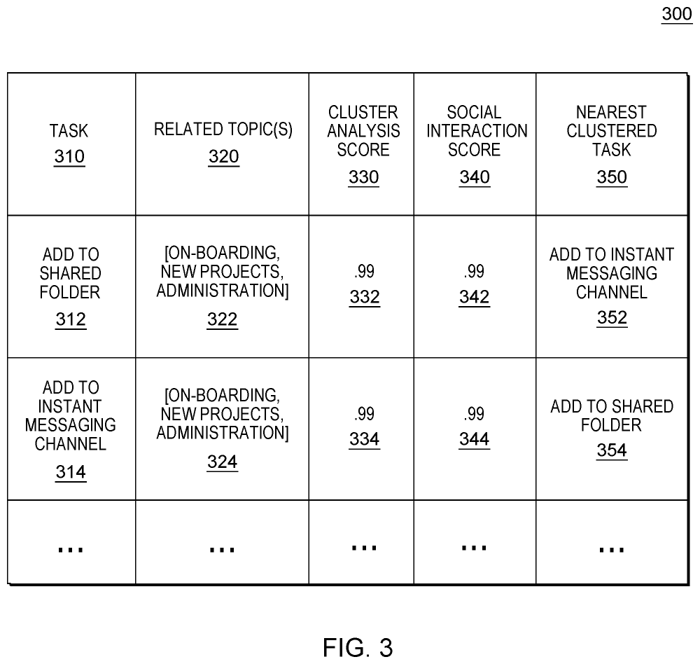

FIG. 3 depicts a task relationship database table 300 in accordance with some embodiments of the present disclosure. The task relationship database table 300 may contain scored and/or clustered indices representing task relationships.

The task relationship database table 300 includes a task 310 column, a related topic(s) 320 column, a cluster analysis score 330 column, a social interaction score 340 column, and a nearest clustered task 350 column. The task 310 column identifies tasks which may have been identified to relate to certain topics and/or task clusters with determined confidence. Social interaction data may be used to calculate, supplement, and/or verify such confidence scores.

The task 310 column includes add to a shared folder 312 and add to an instant messaging channel 314. The related topics 320 column includes a first set of clustered topics which are on-boarding, new projects, and administration 322 and a second set of clustered topics which are on-boarding, new projects, and administration 324.

The cluster analysis score 330 column includes a first cluster score 332 and a second cluster score 334. A cluster score may identify a confidence level that a certain task (e.g., add to shared folder 312) is related to a certain topic (e.g., first set of clustered topics of on-boarding, new projects, and administration 322) based on an analysis of the cluster and the relatedness of the task.

The social interaction score 340 column includes a first social interaction score 342 and a second social interaction score 344. Social interaction scores may identify a confidence level that a certain task (e.g., add to shared folder 312) is related to a certain topic (e.g., first set of clustered topics of on-boarding, new projects, and administration 322) based on an analysis of user social interactions.

The nearest clustered task 350 column includes a first task to add the user to an instant messaging channel 352 and a second task to add the user to a shared folder. The nearest clustered task 350 column may include one or more recommended next tasks for a user (e.g., to add a user to an instant messaging channel 352) after execution of an action (e.g., the action to add the user to a shared folder 312). In some embodiments, the present disclosure may enable the automatic execution of a nearest clustered task 352 identified; in some embodiments, one or more such tasks identified to be above a certain threshold confidence score (e.g., having 95% confidence or greater) may be automatically executed (e.g., by a model or by a system employing a model).

In accordance with the present disclosure, a model (e.g., a TCM) may be built with data (e.g., data about applications 210, actions 220, and contexts 230 of diagram 200 as shown in FIG. 2) that may be analyzed (e.g., tracked as shown in FIG. 1A and semantically analyzed to determine concepts, keywords, and commonalities as shown in visual 160 of FIG. 1B) to identify relationships between datapoints (e.g., as shown in task relationship database table 300 of FIG. 3). In some embodiments of the present disclosure, such a model may be used to streamline and/or automate related tasks.

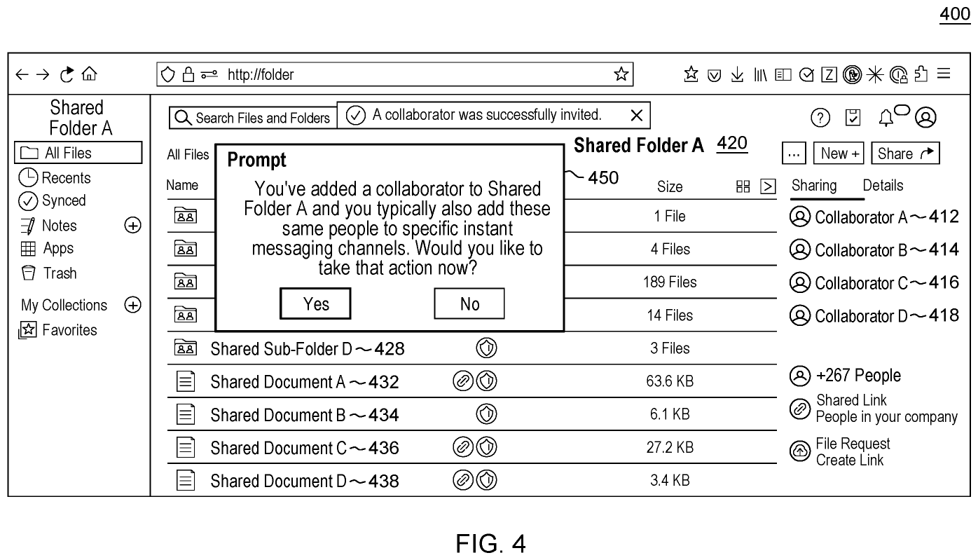

FIG. 4 illustrates an interactive visual 400 in accordance with some embodiments of the present disclosure. In some embodiments, the interactive visual 400 may be a webpage, an application client, or a similar interface; in other embodiments, the interactive visual 400 may be, for example, an API layer that a user may interact with on a headless server.

The interactive visual 400 includes shared folder A 420. Shared folder A 420 includes various sub-folders, such as Shared Sub-Folder D 428, as well as shared documents, such as Shared Document A 432, Shared Document B 434, Shared Document C 436, and Shared Document D 438. Multiple collaborators have been added to shared folder A 420 including Collaborator A 412, Collaborator B 414, Collaborator C 416, and Collaborator D 418.

The interactive visual 400 includes a prompt 450 identifying that a new collaborator has been added to Shared Folder A 420 and offering to add the new collaborator to specific instant messaging channels as a recommended action.

In some embodiments of the present disclosure, alternative actions may be identified in similar or different contexts. In some embodiments of the present disclosure, a model may automatically execute certain actions based on, for example, confidence scores of clustered task relatedness and/or thresholds for relatedness set by a user, an administrator, or alternative standard-setting entity. In some embodiments, a model may automatically execute certain tasks and prompt for other tasks based on, for example, confidence score thresholds.

A computer-implemented method in accordance with the present disclosure may include obtaining social interaction data for a user and monitoring a system for activity of the user. The method may include analyzing the activity and the social interaction data to obtain an analysis. The method may include performing statistical linear regression on the activity and the social interaction data to obtain statistical linear regression data. The method may include deriving a task clustering model based on the analysis and the statistical linear regression data.

In some embodiments of the present disclosure, the method may include generating a visual with the task clustering model. In some embodiments, the method may include providing a visual of a weighted relationship. In some embodiments, the method may include providing the visual to the user, observing a user interaction between the user and the visual, and incorporating the user interaction into a learning database.

In some embodiments of the present disclosure, the method may include identifying related tasks within the activity with the task clustering model. In some embodiments, the method may include providing a visual of a weighted relationship of the related tasks.

In some embodiments of the present disclosure, the method may include weighting relationships of the related tasks based on the social interaction.

In some embodiments of the present disclosure, the method may include implementing the task clustering model in an environment with a given set of constraints. In some embodiments, the environment with given constraints may be an AR/VR environment.

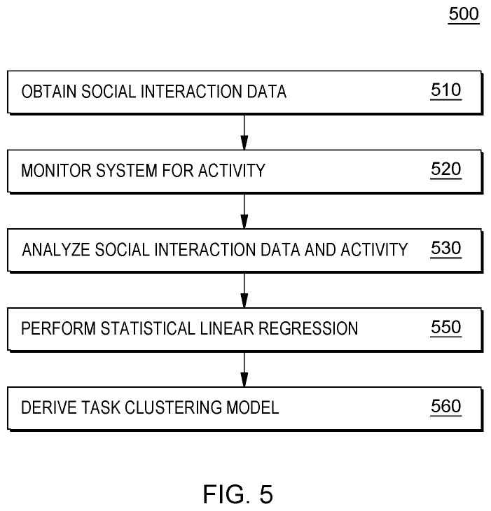

FIG. 5 depicts a computer-implemented method 500 in accordance with some embodiments of the present disclosure. The method 500 includes obtaining 510 social interaction data of a user and monitoring 520 a system for activity of the same user. The method 500 includes analyzing 530 the social interaction data and the activity. The method 500 includes performing 550 statistical linear regression and deriving 560 a task clustering model.

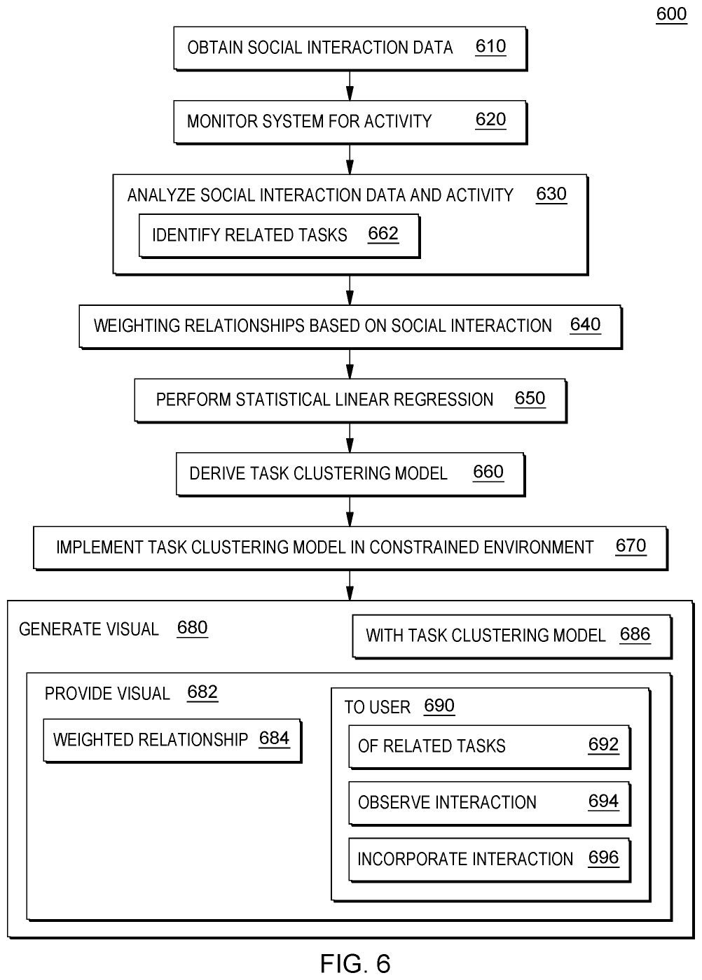

FIG. 6 illustrates a computer-implemented method 600 in accordance with some embodiments of the present disclosure. The method 600 includes obtaining 610 social interaction data of a user and monitoring 620 a system for activity of the same user. The method 600 includes analyzing 630 the social interaction data and the activity as well as weighting 640 the relationships of tasks (e.g., based on the social interaction data of the user). The method 600 includes performing 650 statistical linear regression and deriving 660 a task clustering model. The method 600 includes implementing 670 a task clustering model (TCM) in a constrained environment (e.g., an AR/VR environment) and generating 680 a visual.

Analyzing 630 the social interaction data and the activity may include identifying 662 related tasks. In some embodiments, the TCM may be used to identify one or more related tasks.

Generating 680 a visual may include providing 682 a visual. The visual may be generated using a task clustering model 686. The visual may be a graphic representation of a weighted relationship 684 such as, for example, one or more bar graphs (e.g., the visual 160 of FIG. 1B). The visual may be provided to a user 690 (e.g., the user whose social interaction data and activity data was analyzed). The visual provided to the user 690 may be of related tasks 692. In providing 682 the visual to the user 690, the method 600 may include observing 694 a user interaction between the user and the visual and incorporating 696 the user interaction into a learning database (e.g., for future learning of a TCM).

A computer program product in accordance with the present disclosure may include a computer readable storage medium having program instructions embodied therewith. The program instructions may be executable by a processor to cause the processor to perform a function. The function may include obtaining social interaction data for a user and monitoring a system for activity of the user. The function may include analyzing the activity and the social interaction data to obtain an analysis. The function may include performing statistical linear regression on the activity and the social interaction data to obtain statistical linear regression data. The function may include deriving a task clustering model based on the analysis and the statistical linear regression data.

In some embodiments of the present disclosure, the function may include generating a visual with the task clustering model. In some embodiments, the function may include providing a visual of a weighted relationship. In some embodiments, the function may include providing the visual to the user, observing a user interaction between the user and the visual, and incorporating the user interaction into a learning database.

In some embodiments of the present disclosure, the function may include identifying related tasks within the activity with the task clustering model. In some embodiments, the function may include providing a visual of a weighted relationship of the related tasks.

In some embodiments of the present disclosure, the function may include weighting relationships of the related tasks based on the social interaction.

In some embodiments of the present disclosure, the function may include implementing the task clustering model in an environment with a given set of constraints. In some embodiments, the environment with given constraints may be an AR/VR environment.

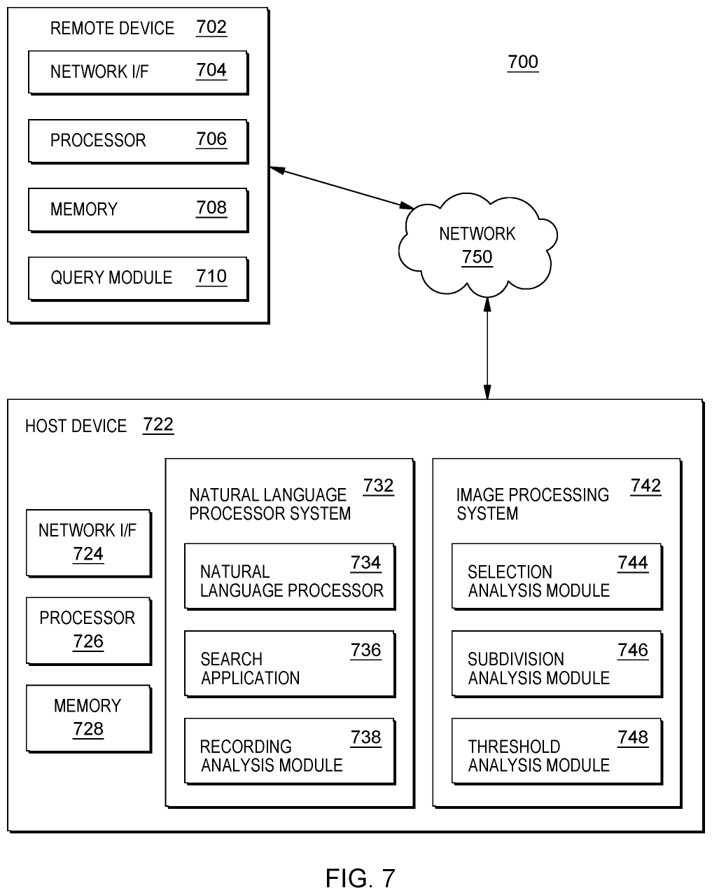

Some embodiments of the present disclosure may utilize a natural language parsing and/or subparsing component. Thus, aspects of the disclosure may relate to natural language processing. Accordingly, an understanding of the embodiments of the present invention may be aided by describing embodiments of natural language processing systems and the environments in which these systems may operate. Turning now to FIG. 7, illustrated is a block diagram of an example computing environment 700 in which illustrative embodiments of the present disclosure may be implemented. In some embodiments, the computing environment 700 may include a remote device 702 and a host device 722.

Consistent with various embodiments of the present disclosure, the host device 722 and the remote device 702 may be computer systems. The remote device 702 and the host device 722 may include one or more processors 706 and 726 and one or more memories 708 and 728, respectively. The remote device 702 and the host device 722 may be configured to communicate with each other through an internal or external network interface 704 and 724. The network interfaces 704 and 724 may be modems or network interface cards. The remote device 702 and/or the host device 722 may be equipped with a display such as a monitor. Additionally, the remote device 702 and/or the host device 722 may include optional input devices (e.g., a keyboard, mouse, scanner, or other input device) and/or any commercially available or custom software (e.g., browser software, communications software, server software, natural language processing software, search engine and/or web crawling software, filter modules for filtering content based upon predefined parameters, etc.). In some embodiments, the remote device 702 and/or the host device 722 may be servers, desktops, laptops, or hand-held devices.

The remote device 702 and the host device 722 may be distant from each other and communicate over a network 750. In some embodiments, the host device 722 may be a central hub from which remote device 702 can establish a communication connection, such as in a client-server networking model. Alternatively, the host device 722 and remote device 702 may be configured in any other suitable networking relationship (e.g., in a peer-to-peer configuration or using any other network topology).

In some embodiments, the network 750 can be implemented using any number of any suitable communications media. For example, the network 750 may be a wide area network (WAN), a local area network (LAN), an internet, or an intranet. In certain embodiments, the remote device 702 and the host device 722 may be local to each other and communicate via any appropriate local communication medium. For example, the remote device 702 and the host device 722 may communicate using a local area network (LAN), one or more hardwire connections, a wireless link or router, or an intranet. In some embodiments, the remote device 702 and the host device 722 may be communicatively coupled using a combination of one or more networks and/or one or more local connections. For example, the remote device 702 may be hardwired to the host device 722 (e.g., connected with an Ethernet cable) or the remote device 702 may communicate with the host device using the network 750 (e.g., over the Internet).

In some embodiments, the network 750 can be implemented within a cloud computing environment or using one or more cloud computing services. Consistent with various embodiments, a cloud computing environment may include a network-based, distributed data processing system that provides one or more cloud computing services. Further, a cloud computing environment may include many computers (e.g., hundreds or thousands of computers or more) disposed within one or more data centers and configured to share resources over the network 750.

In some embodiments, the remote device 702 may enable a user to input (or may input automatically with or without a user) a query (e.g., is any part of a recording artificial, etc.) to the host device 722 in order to identify subdivisions of a recording that include a particular subject. For example, the remote device 702 may include a query module 710 and a user interface (UI). The query module 710 may be in the form of a web browser or any other suitable software module, and the UI may be any type of interface (e.g., command line prompts, menu screens, graphical user interfaces). The UI may allow a user to interact with the remote device 702 to input, using the query module 710, a query to the host device 722, which may receive the query.

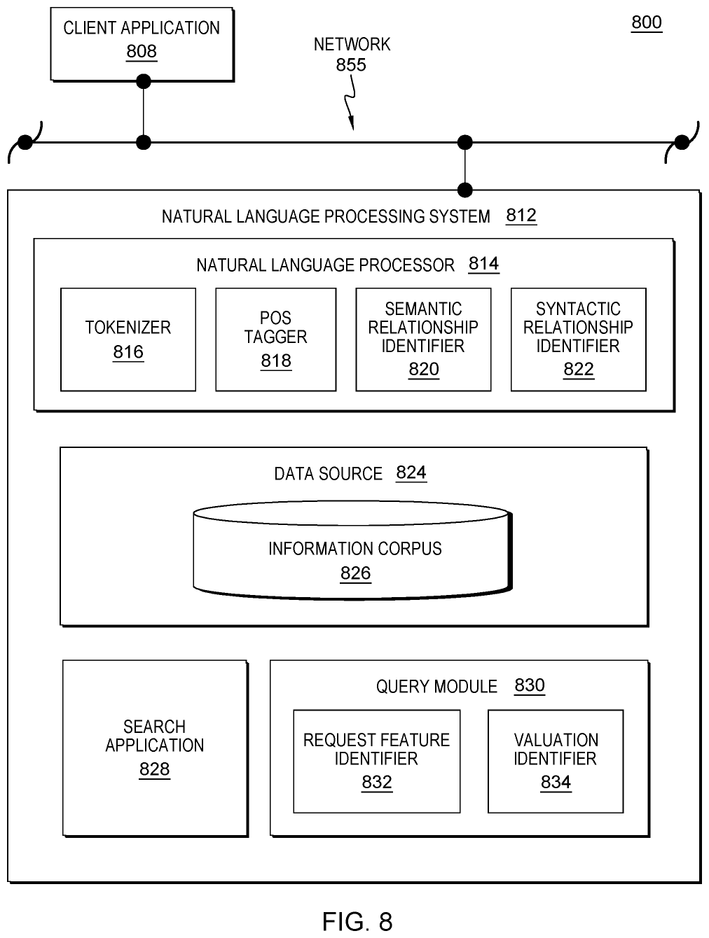

In some embodiments, the host device 722 may include a natural language processing system 732. The natural language processing system 732 may include a natural language processor 734, a search application 736, and a recording module 738. The natural language processor 734 may include numerous subcomponents, such as a tokenizer, a part-of-speech (POS) tagger, a semantic relationship identifier, and a syntactic relationship identifier. An example natural language processor is discussed in more detail in reference to FIG. 8.

The search application 736 may be implemented using a conventional or other search engine and may be distributed across multiple computer systems. The search application 736 may be configured to search one or more databases (e.g., repositories) or other computer systems for content that is related to a query submitted by the remote device 702. For example, the search application 736 may be configured to search dictionaries, papers, and/or archived reports to help identify a particular subject related to a query provided for a class. The recording analysis module 738 may be configured to analyze a recording to identify a particular subject (e.g., of the query). The recording analysis module 738 may include one or more modules or units, and may utilize the search application 736, to perform its functions (e.g., to identify a particular subject in a recording), as discussed in more detail in reference to FIG. 8.

In some embodiments, the host device 722 may include an image processing system 742. The image processing system 742 may be configured to analyze images associated with a recording to create an image analysis. The image processing system 742 may utilize one or more models, modules, or units to perform its functions (e.g., to analyze the images associated with the recording and generate an image analysis). For example, the image processing system 742 may include one or more image processing models that are configured to identify specific images related to a recording. The image processing models may include a section analysis module 744 to analyze single images associated with the recording and to identify the location of one or more features of the single images. As another example, the image processing system 742 may include a subdivision module 746 to group multiple images together identified to have a common feature of the one or more features. In some embodiments, image processing modules may be implemented as software modules. For example, the image processing system 742 may include a section analysis module and a subdivision analysis module. In some embodiments, a single software module may be configured to analyze the image(s) using image processing models.

In some embodiments, the image processing system 742 may include a threshold analysis module 748. The threshold analysis module 748 may be configured to compare the instances of a particular subject identified in a subdivision of sections of the recording against a threshold number of instances. The threshold analysis module 748 may then determine if the subdivision should be displayed to a user.

In some embodiments, the host device may have an optical character recognition (OCR) module. The OCR module may be configured to receive a recording sent from the remote device 702 and perform optical character recognition (or a related process) on the recording to convert it into machine-encoded text so that the natural language processing system 732 may perform NLP on the report. For example, a remote device 702 may transmit a video of a medical procedure to the host device 722. The OCR module may convert the video into machine-encoded text and then the converted video may be sent to the natural language processing system 732 for analysis. In some embodiments, the OCR module may be a subcomponent of the natural language processing system 732. In other embodiments, the OCR module may be a standalone module within the host device 722. In still other embodiments, the OCR module may be located on the remote device 702 and may perform OCR on the recording before the recording is sent to the host device 722.

While FIG. 7 illustrates a computing environment 700 with a single host device 722 and a remote device 702, suitable computing environments for implementing embodiments of this disclosure may include any number of remote devices and host devices. The various models, modules, systems, and components illustrated in FIG. 7 may exist, if at all, across a plurality of host devices and remote devices. For example, some embodiments may include two host devices. The two host devices may be communicatively coupled using any suitable communications connection (e.g., using a WAN, a LAN, a wired connection, an intranet, or the Internet). The first host device may include a natural language processing system configured to receive and analyze a video, and the second host device may include an image processing system configured to receive and analyze .GIF files to generate an image analysis.

It is noted that FIG. 7 is intended to depict the representative major components of an exemplary computing environment 700. In some embodiments, however, individual components may have greater or lesser complexity than as represented in FIG. 7, components other than or in addition to those shown in FIG. 7 may be present, and the number, type, and configuration of such components may vary.

Referring now to FIG. 8, shown is a block diagram of an exemplary system architecture 800 including a natural language processing system 812 configured to analyze data to identify objects of interest (e.g., possible anomalies, natural data, etc.), in accordance with embodiments of the present disclosure. In some embodiments, a remote device (such as remote device 702 of FIG. 7) may submit a text segment and/or a corpus to be analyzed to the natural language processing system 812 which may be housed on a host device (such as host device 722 of FIG. 7). Such a remote device may include a client application 808, which may itself involve one or more entities operable to generate or modify information associated with the recording and/or query that is then dispatched to a natural language processing system 812 via a network 855.

Consistent with various embodiments of the present disclosure, the natural language processing system 812 may respond to text segment and corpus submissions sent by a client application 808. Specifically, the natural language processing system 812 may analyze a received text segment and/or corpus (e.g., video, news article, etc.) to identify an object of interest. In some embodiments, the natural language processing system 812 may include a natural language processor 814, data sources 824, a search application 828, and a query module 830. The natural language processor 814 may be a computer module that analyzes the recording and the query. The natural language processor 814 may perform various methods and techniques for analyzing recordings and/or queries (e.g., syntactic analysis, semantic analysis, etc.). The natural language processor 814 may be configured to recognize and analyze any number of natural languages. In some embodiments, the natural language processor 814 may group one or more sections of a text into one or more subdivisions. Further, the natural language processor 814 may include various modules to perform analyses of text or other forms of data (e.g., recordings, etc.). These modules may include, but are not limited to, a tokenizer 816, a part-of-speech (POS) tagger 818 (e.g., which may tag each of the one or more sections of text in which the particular object of interest is identified), a semantic relationship identifier 820, and a syntactic relationship identifier 822.

In some embodiments, the tokenizer 816 may be a computer module that performs lexical analysis. The tokenizer 816 may convert a sequence of characters (e.g., images, sounds, etc.) into a sequence of tokens. A token may be a string of characters included in a recording and categorized as a meaningful symbol. Further, in some embodiments, the tokenizer 816 may identify word boundaries in a body of text and break any text within the body of text into their component text elements, such as words, multiword tokens, numbers, and punctuation marks. In some embodiments, the tokenizer 816 may receive a string of characters, identify the lexemes in the string, and categorize them into tokens.

Consistent with various embodiments, the POS tagger 818 may be a computer module that marks up a word in a recording to correspond to a particular part of speech. The POS tagger 818 may read a passage or other text in natural language and assign a part of speech to each word or other token. The POS tagger 818 may determine the part of speech to which a word (or other spoken element) corresponds based on the definition of the word and the context of the word. The context of a word may be based on its relationship with adjacent and related words in a phrase, sentence, or paragraph. In some embodiments, the context of a word may be dependent on one or more previously analyzed body of texts and/or corpora (e.g., the content of one text segment may shed light on the meaning of one or more objects of interest in another text segment). Examples of parts of speech that may be assigned to words include, but are not limited to, nouns, verbs, adjectives, adverbs, and the like. Examples of other part of speech categories that POS tagger 818 may assign include, but are not limited to, comparative or superlative adverbs, wh-adverbs, conjunctions, determiners, negative particles, possessive markers, prepositions, wh-pronouns, and the like. In some embodiments, the POS tagger 818 may tag or otherwise annotate tokens of a recording with part of speech categories. In some embodiments, the POS tagger 818 may tag tokens or words of a recording to be parsed by the natural language processing system 812.

In some embodiments, the semantic relationship identifier 820 may be a computer module that may be configured to identify semantic relationships of recognized subjects (e.g., words, phrases, images, etc.) in a body of text/corpus. In some embodiments, the semantic relationship identifier 820 may determine functional dependencies between entities and other semantic relationships.

Consistent with various embodiments, the syntactic relationship identifier 822 may be a computer module that may be configured to identify syntactic relationships in a body of text/corpus composed of tokens. The syntactic relationship identifier 822 may determine the grammatical structure of sentences such as, for example, which groups of words are associated as phrases and which word is the subject or object of a verb. The syntactic relationship identifier 822 may conform to formal grammar.

In some embodiments, the natural language processor 814 may be a computer module that may group sections of a recording into subdivisions and generate corresponding data structures for one or more subdivisions of the recording. For example, in response to receiving a text segment at the natural language processing system 812, the natural language processor 814 may output subdivisions of the text segment as data structures. In some embodiments, a subdivision may be represented in the form of a graph structure. To generate the subdivision, the natural language processor 814 may trigger computer modules 816-822.

In some embodiments, the output of natural language processor 814 may be used by search application 828 to perform a search of a set of (i.e., one or more) corpora to retrieve one or more subdivisions including a particular subject associated with a query (e.g., in regard to an object of interest) and send the output to an image processing system and to a comparator. As used herein, a corpus may refer to one or more data sources, such as a data source 824 of FIG. 8. In some embodiments, data sources 824 may include video libraries, data warehouses, information corpora, data models, and/or document repositories. In some embodiments, the data sources 824 may include an information corpus 826. The information corpus 826 may enable data storage and retrieval. In some embodiments, the information corpus 826 may be a subject repository that houses a standardized, consistent, clean, and integrated list of images and text. For example, an information corpus 826 may include teaching presentations that include step by step images and comments on how to perform a function. Data may be sourced from various operational systems. Data stored in an information corpus 826 may be structured in a way to specifically address reporting and analytic requirements. In some embodiments, an information corpus 826 may be a relational database.

In some embodiments, a query module 830 may be a computer module that identifies objects of interest within sections of a text, or other forms of data. In some embodiments, a query module 830 may include a request feature identifier 832 and a valuation identifier 834. When a query is received by the natural language processing system 812, the query module 830 may be configured to analyze text using natural language processing to identify an object of interest. The query module 830 may first identity one or more objects of interest in the text using the natural language processor 814 and related subcomponents 816-822. After identifying the one or more objects of interest, the request feature identifier 832 may identify one or more common objects of interest (e.g., anomalies, artificial content, natural data, etc.) present in sections of the text (e.g., the one or more text segments of the text). In some embodiments, the common objects of interest in the sections may be the same object of interest that is identified. Once a common object of interest is identified, the request feature identifier 832 may be configured to transmit the text segments that include the common object of interest to an image processing system (shown in FIG. 7) and/or to a comparator.

After identifying common objects of interest using the request feature identifier 832, the query module may group sections of text having common objects of interest. The valuation identifier 834 may then provide a value to each text segment indicating how close the object of interest in each text segment is related to one another (and thus indicates artificial and/or real data). In some embodiments, the particular subject may have one or more of the common objects of interest identified in the one or more sections of text. After identifying a particular object of interest relating to the query (e.g., identifying that one or more of the common objects of interest may be an anomaly), the valuation identifier 834 may be configured to transmit the criterion to an image processing system (shown in FIG. 7) and/or to a comparator (which may then determine the validity of the common and/or particular objects of interest).

It is noted that various aspects of the present disclosure may be described by narrative text, flowcharts, block diagrams of computer systems, and/or block diagrams of the machine logic included in computer program product (CPP) embodiments. With respect to any flowcharts (depending upon the technology involved), the operations can be performed in a different order than what is shown in the flowchart. For example, two operations shown in successive flowchart blocks may be performed in reverse order, as a single integrated step, concurrently, or in a manner at least partially overlapping in time. A computer program product embodiment (“CPP embodiment”) is a term used in the present disclosure that may describe any set of one or more storage media (or “mediums”) collectively included in a set of one or more storage devices.

The storage media may collectively include machine readable code corresponding to instructions and/or data for performing computer operations. A “storage device” may refer to any tangible hardware or device that can retain and store instructions for use by a computer processor. Without limitation, the computer readable storage medium may include an electronic storage medium, a magnetic storage medium, an optical storage medium, an electromagnetic storage medium, a semiconductor storage medium, a mechanical storage medium, and/or any combination thereof. Some known types of storage devices that include mediums referenced herein may include a diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc), or any suitable combination thereof. A computer-readable storage medium should not be construed as storage in the form of one or more transitory signals per se such as radio waves, other freely propagating electromagnetic waves, electromagnetic waves propagating through a waveguide, light pulses passing through a fiber optic cable, electrical signals communicated through a wire, and/or other transmission media. As understood by those skilled in the art, data is typically moved at some occasional points in time during normal operations of a storage device, such as during access, de-fragmentation, or garbage collection, but this does not render the storage device transitory because the data is not transitory while it is stored.

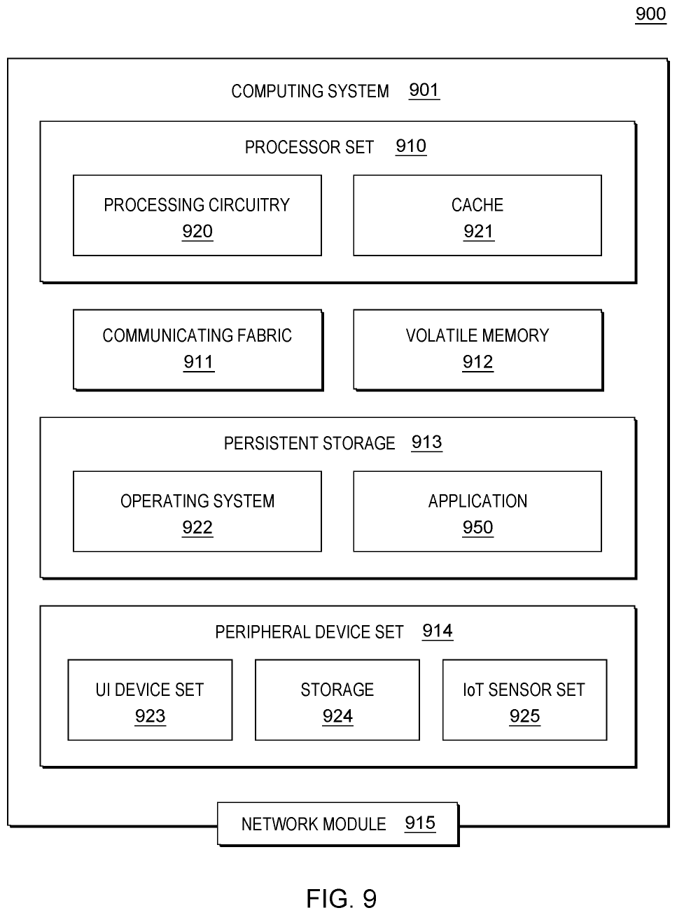

Referring now to FIG. 9, illustrated is a block diagram describing an embodiment of a computing system 901 within in a computing environment 900. The computing environment 900 may be a simplified example of a computing device (e.g., a physical bare metal system and/or a virtual system) capable of performing the computing operations described herein. Computing system 901 may be representative of the one or more computing systems or devices implemented in accordance with the embodiments of the present disclosure and further described below in detail. It should be appreciated that FIG. 9 provides only an illustration of one implementation of a computing system 901 and does not imply any limitations regarding the environments in which different embodiments may be implemented. In general, the components illustrated in FIG. 9 may be representative of an electronic device, either physical or virtualized, capable of executing machine-readable program instructions.

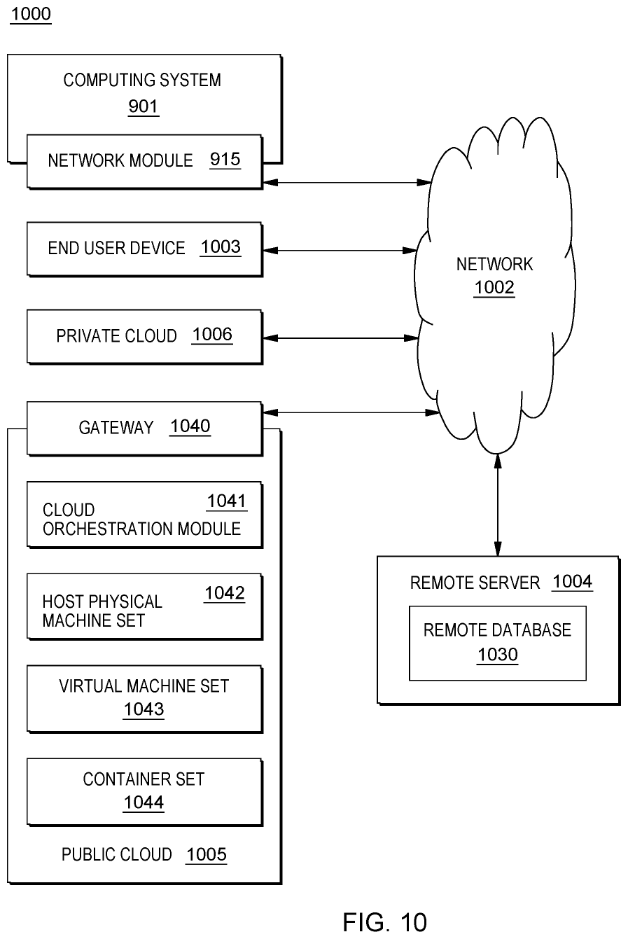

Embodiments of computing system 901 may take the form of a desktop computer, laptop computer, tablet computer, smart phone, smart watch or other wearable computer, mainframe computer, server, quantum computer, a non-conventional computer system such as an autonomous vehicle or home appliance, or any other form of computer or mobile device now known or to be developed in the future that is capable of running an application 950, accessing a network (e.g., network 1002 of FIG. 10), or querying a database (e.g., remote database 1030 of FIG. 10). Performance of a computer-implemented method executed by a computing system 901 may be distributed among multiple computers and/or between multiple locations. Computing system 901 may be located as part of a cloud network, even though it is not shown within a cloud in FIG. 9 or FIG. 10. Moreover, computing system 901 is not required to be in a cloud network except to any extent as may be affirmatively indicated.

The processor set 910 includes one or more computer processors of any type now known or to be developed in the future. Processing circuitry 920 may be distributed over multiple packages such as, for example, multiple coordinated integrated circuit chips. Processing circuitry 920 may implement multiple processor threads and/or multiple processor cores. The cache 921 may refer to memory that is located on the processor chip package(s) and/or may be used for data and/or code that can be made available for rapid access by the threads or cores running on the processor set 910. Cache 921 memories can be organized into multiple levels depending upon relative proximity to the processing circuitry 920. Alternatively, some or all of the cache 921 may be located “off chip.” In some computing environments, the processor set 910 may be designed for working with qubits and performing quantum computing.

Computer readable program instructions can be loaded onto the computing system 901 to cause a series of operational steps to be performed by the processor set 910 of the computing system 901 and thereby implement a computer-implemented method. Execution of the instructions can instantiate the methods specified in flowcharts and/or narrative descriptions of computer-implemented methods included in this specification (collectively referred to as “the inventive methods”). The computer readable program instructions can be stored in various types of computer readable storage media, such as cache 921 and the other storage media discussed herein. The program instructions, and associated data, can be accessed by the processor set 910 to control and direct performance of the inventive methods. In the computing environments of FIG. 9 and FIG. 10, at least some of the instructions for performing the inventive methods may be stored in persistent storage 913, volatile memory 912, and/or cache 921 as application(s) 950 comprising one or more running processes, services, programs, and installed components thereof. For example, program instructions, processes, services, and installed components thereof may include the components and/or sub-components of a computer system (e.g., the remote device 701 as shown in FIG. 7) performing a method for building a task clustering model (e.g., the computer implemented method 500 of FIG. 5).

The communication fabric 911 may refer to signal conduction paths that may allow the various components of the computing system 901 to communicate with each other. For example, communications fabric 911 may provide for electronic communication among the processor set 910, volatile memory 912, persistent storage 913, peripheral device set 914, and/or network module 915. The communication fabric 911 may be made of switches and/or electrically conductive paths, such as the switches and electrically conductive paths that make up busses, bridges, physical input/output ports, and the like. Other types of signal communication paths may be used such as fiber optic communication paths and/or wireless communication paths.

The volatile memory 912 may refer to any type of volatile memory now known or to be developed in the future. The volatile memory 912 may be characterized by random access; random access is not required unless affirmatively indicated. Examples include dynamic-type random access memory (RAM) or static-type RAM. In the computing system 901, the volatile memory 912 is located in a single package and can be internal to computing system 901; in some embodiments, either alternatively or additionally, the volatile memory 912 may be distributed over multiple packages and/or located externally with respect to the computing system 901. The application 950, along with any program(s), processes, services, and installed components thereof, described herein, may be stored in volatile memory 912 and/or persistent storage 913 for execution and/or access by one or more of the respective processor sets 910 of the computing system 901.

Persistent storage 913 may be any form of non-volatile storage for computers that may be currently known or developed in the future. The non-volatility of this storage means that the stored data may be maintained regardless of whether power is being supplied to the computing system 901 and/or directly to persistent storage 913. Persistent storage 913 may be a read-only memory (ROM); at least a portion of the persistent storage 913 may allow writing of data, deletion of data, and/or re-writing of data. Some forms of persistent storage 913 may include magnetic disks, solid-state storage devices, hard drives, flash-based memory, erasable read-only memories (EPROM), and semi-conductor storage devices. An operating system 922 may take several forms, such as various known proprietary operating systems or open-source portable operating system interface-type operating systems that employ a kernel.

The peripheral device set 914 may include one or more peripheral devices connected to computing system 901, for example, via an input/output (I/O) interface. Data communication connections between the peripheral devices and the other components of computing system 901 may be implemented using various methods. For example, data communication connections may be made using short-range wireless technology (e.g., a Bluetooth® connection), Near-Field Communication (NFC), wired connections or cables (e.g., universal serial bus (USB) cables), insertion-type connections (e.g., a secure digital (SD) card), connections made though local area communication networks, and/or wide area networks (e.g., the internet).

In various embodiments, the UI device set 923 may include components such as a display screen, speaker, microphone, wearable devices (e.g., goggles, headsets, and smart watches), keyboard, mouse, printer, touchpad, game controllers, and/or haptic feedback devices.

The storage 924 may include external storage (e.g., an external hard drive) or insertable storage (e.g., an SD card). The storage 924 may be persistent and/or volatile. In some embodiments, the storage 924 may take the form of a quantum computing storage device for storing data in the form of qubits.

In some embodiments, networks of computing systems 901 may utilize clustered computing and components acting as a single pool of seamless resources when accessed through a network by one or more computing systems 901. For example, networks of computing systems 901 may utilize a storage area network (SAN) that is shared by multiple, geographically distributed computer systems 901 or network-attached storage (NAS) applications.

An IoT sensor set 925 may be made up of sensors that can be used in Internet-of-Things applications. A sensor may be a temperature sensor, motion sensor, infrared sensor, or any other type of known sensor type. One or more sensors may be communicably connected and/or used as the IoT sensor set 925 in whole or in part.

The network module 915 may include a collection of computer software, hardware, and/or firmware that allows the computing system 901 to communicate with other computer systems through a network 902 such as a LAN or WAN. The network module 915 may include hardware (e.g., modems or wireless signal transceivers), software (e.g., for packetizing and/or de-packetizing data for communication network transmission), and/or web browser software (e.g., for communicating data over the network).

In some embodiments, network control functions and network forwarding functions of the network module 915 may be performed on the same physical hardware device. In some embodiments, the control functions and the forwarding functions of network module 915 may be performed on physically separate devices such that the control functions manage several different network hardware devices; for example, embodiments that utilize software-defined networking (SDN) may perform control functions and forwarding functions of the network module 915 on physically separate devices. Computer readable program instructions for performing the inventive methods may be downloaded to the computing system 901 from an external computer or external storage device through a network adapter card and/or network interface included in the network module 915.

Continuing, FIG. 10 depicts a computing environment 1000 operating as part of a network. The computing environment 1000 of FIG. 10 may be an extension of the computing environment 900 of FIG. 9. In addition to computing system 901, computing environment 1000 may include a network 1002 (e.g., a WAN or other type of computer network) connecting the computing system 901 to an end user device (EUD) 1003, remote server 1004, public cloud 1005, and/or private cloud 1006.

In this embodiment, computing system 901 includes processor set 910 (including the processing circuitry 920 and the cache 921), the communication fabric 911, the volatile memory 912, the persistent storage 913 (including the operating system 922 and the program(s) 950, as identified above), the peripheral device set 914 (including the user interface (UI), the device set 923, the storage 924, and the Internet of Things (IoT) sensor set 925), and the network module 915 of FIG. 9.

In this embodiment, the remote server 1004 includes the remote database 1030. In this embodiment, the public cloud 1005 includes gateway 1040, cloud orchestration module 1041, host physical machine set 1042, virtual machine set 1043, and/or container set 1044.

The network 1002 may be comprised of wired and/or wireless connections. For example, connections may be comprised of computer hardware such as copper transmission cables, optical transmission fibers, wireless transmission, routers, firewalls, switches, gateway computers, and/or edge servers. The network 1002 may be described as a WAN (e.g., the internet) capable of communicating computer data over non-local distances by any technology for communicating computer data; the network 1002 may make use of technology now known or to be developed in the future. In some embodiments, the WAN may be replaced and/or supplemented by LANs designed to communicate data between devices located in a local area (e.g., a wireless network). Other types of networks that can be used to interconnect the one or more computer systems 901, EUDs 1003, remote servers 1004, private cloud 1006, and/or public cloud 1005 may include a Wireless Local Area Network (WLAN), home area network (HAN), backbone network (BBN), peer to peer network (P2P), campus network, enterprise network, the Internet, single- or multi-tenant cloud computing networks, the Public Switched Telephone Network (PSTN), and any other network or network topology known by a person skilled in the art to interconnect computing systems 901.

The EUD 1003 may include any computer device that can be used and/or controlled by an end user; for example, a customer of an enterprise that operates computing system 901. The EUD 1003 may take any of the forms discussed above in connection with computing system 901. The EUD 1003 may receive helpful and/or useful data from the operations of the computing system 901. For example, in a hypothetical case where the computing system 901 provides a recommendation to an end user, the recommendation may be communicated from the network module 915 of the computing system 901 through a WAN network 1002 to the EUD 1003; in this example, the EUD 1003 may display (or otherwise present) the recommendation to an end user. In some embodiments, the EUD 1003 may be a client device, (e.g., a thin client), thick client, mobile computing device (e.g., a smart phone), mainframe computer, desktop computer, and/or the like.

A remote server 1004 may be any computing system that serves at least some data and/or functionality to the computing system 901. The remote server 1004 may be controlled and used by the same entity that operates computing system 901. The remote server 1004 represents the one or more machines that collect and store helpful and/or useful data for use by other computers (e.g., computing system 901). For example, in a hypothetical case where the computing system 901 is designed and programmed to provide a recommendation based on historical data, the historical data may be provided to the computing system 901 via a remote database 1030 of a remote server 1004.

Public cloud 1005 may be any computing systems available for use by multiple entities that provide on-demand availability of computer system resources and/or other computer capabilities including data storage (e.g., cloud storage) and computing power without direct active management by the user. The direct and active management of the computing resources of the public cloud 1005 may be performed by the computer hardware and/or software of a cloud orchestration module 1041. The public cloud 1005 may communicate through the network 1002 via a gateway 1040; the gateway 1040 may be a collection of computer software, hardware, and/or firmware that allows the public cloud 1005 to communicate through the network 1002.

The computing resources provided by the public cloud 1005 may be implemented by a virtual computing environment (VCE) or multiple VCEs that may run on one or more computers making up a host physical machine set 1042 and/or the universe of physical computers in and/or available to public cloud 905. A VCE may take the form of a virtual machine (VM) from the virtual machine set 1043 and/or containers from the container set 1044.

VCEs may be stored as images. One or more VCEs may be stored as one or more images and/or may be transferred among and/or between one or more various physical machine hosts either as images and/or after instantiation of the VCE. A new active instance of the VCE may be instantiated from the image. Two types of VCEs may include VMs and containers. A container is a VCE that uses operating system-level virtualization in which the kernel may allow the existence of multiple isolated user-space instances called containers. These isolated user-space instances may behave as physical computers from the point of view of the programs 950 running in them. An application 950 running on an operating system 922 may utilize all resources of that computer such as connected devices, files, folders, network shares, CPU power, and quantifiable hardware capabilities. The applications 950 running inside a container of the container set 944 may only use the contents of the container and devices assigned to the container; this feature may be referred to as containerization. The cloud orchestration module 1041 may manage the transfer and storage of images, deploy new instantiations of one or more VCEs, and manage active instantiations of VCE deployments.

Private cloud 1006 may be similar to public cloud 1005 except that the computing resources may only be available for use by a single enterprise. While the private cloud 1006 is depicted as being in communication with the network 1002 (e.g., the Internet), in other embodiments, a private cloud 906 may be disconnected from the internet entirely and only accessible through a local/private network.

In some embodiments, a hybrid cloud may be used; a hybrid cloud may refer to a composition of multiple clouds of different types (e.g., private, community, and/or public cloud types). In a hybrid cloud system, the plurality of clouds may be implemented or operated by different vendors. Each of the multiple clouds remains a separate and discrete entity; the larger hybrid cloud architecture is bound together by standardized or proprietary technology that enables orchestration, management, and/or data/application portability between the multiple constituent clouds. In this embodiment, the public cloud 1005 and the private cloud 1006 may be both part of a larger hybrid cloud environment.

Although the present disclosure has been described in terms of specific embodiments, it is anticipated that alterations and modifications thereof will become apparent to the skilled in the art. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application, or the technical improvement over technologies found in the marketplace or to enable others of ordinary skill in the art to understand the embodiments disclosed herein. Therefore, it is intended that the following claims be interpreted as covering all such alterations and modifications as fall within the true spirit and scope of the disclosure.

What is claimed is:

1. A system, said system comprising:
a memory; and
a processor in communication with said memory, said processor being configured to perform operations, said operations comprising:
obtaining social interaction data for a user;
monitoring a system for activity of said user;
analyzing said activity and said social interaction data to obtain an analysis;
performing statistical linear regression on said activity and said social interaction data to obtain statistical linear regression data; and
deriving a task clustering model based on said analysis and said statistical linear regression data.

2. The system of claim 1, said operations further comprising:
generating a visual with said task clustering model.

3. The system of claim 2, said operations further comprising:
providing a visual of a weighted relationship.

4. The system of claim 2, said operations further comprising:
providing said visual to said user;
observing a user interaction between said user and said visual; and
incorporating said user interaction into a learning database.

5. The system of claim 1, said operations further comprising:
identifying related tasks within said activity with said task clustering model.

6. The system of claim 5, said operations further comprising:
providing a visual of a weighted relationship of said related tasks.

7. The system of claim 1, said operations further comprising:
weighting relationships of said related tasks based on said social interaction.

8. A computer-implemented method, said method comprising:
obtaining social interaction data for a user;
monitoring a system for activity of said user;
analyzing said activity and said social interaction data to obtain an analysis;
performing statistical linear regression on said activity and said social interaction data to obtain statistical linear regression data; and
deriving a task clustering model based on said analysis and said statistical linear regression data.

9. The computer-implemented method of claim 8, further comprising:
generating a visual with said task clustering model.

10. The computer-implemented method of claim 9, further comprising:
providing a visual of a weighted relationship.

11. The computer-implemented method of claim 9, further comprising:
providing said visual to said user;
observing a user interaction between said user and said visual; and
incorporating said user interaction into a learning database.

12. The computer-implemented method of claim 11, further comprising:
providing a visual of a weighted relationship of said related tasks.

13. The computer-implemented method of claim 8, further comprising:
weighting relationships of said related tasks based on said social interaction.

14. The computer-implemented method of claim 8, further comprising:
implementing said task clustering model in an environment with a given set of constraints.

15. A computer program product, said computer program product comprising a computer readable storage medium having program instructions embodied therewith, said program instructions executable by a processor to cause said processor to perform a function, said function comprising:
obtaining social interaction data for a user;
monitoring a system for activity of said user;
analyzing said activity and said social interaction data to obtain an analysis;
performing statistical linear regression on said activity and said social interaction data to obtain statistical linear regression data; and
deriving a task clustering model based on said analysis and said statistical linear regression data.

16. The computer program product of claim 15, said function further comprising:
generating a visual with said task clustering model.

17. The computer program product of claim 16, said function further comprising:
providing a visual of a weighted relationship.

18. The computer program product of claim 16, said function further comprising:
providing said visual to said user;
observing a user interaction between said user and said visual; and
incorporating said user interaction into a learning database.

19. The computer program product of claim 15, said function further comprising:
identifying related tasks within said activity with said task clustering model.

20. The computer program product of claim 15, said function further comprising:
weighting relationships of said related tasks based on said social interaction.
